(19) United States
(12) Patent Application Publication
(10) Pub. No.: US 2010/0058754 A1
(43) Pub. Date: Mar. 11, 2010

(54) Wave energy machine

(76) Inventors: Bright Fong, Fullerton, CA (US); Jemi Fong, Huntington Beach, CA (US)

Correspondence Address: BRIGHT FONG, 2454 CAMBRIDGE AVENUE, FULLERTON, CA, 92835, US

(21) Appl. No.: 12/231,912

(22) Filed: Sep. 8, 2008

(51) Int. Cl. F03B 13/16

(52) U.S. Cl. 60/506

(57) ABSTRACT

This invention relates to an apparatus for harvesting both potential and kinetic energy stored in ocean waves. The ocean's surface waves can simultaneously cause a cylindrical float to move up and down as well as rotate. By incorporating this float into a mechanical rectifying assembly comprised of unidirectional drive gears, the float's vertical motion as well as its rotation can be converted into continuous, one-way rotation of a power output shaft to drive an electric generator.

This arrangement achieves a wave energy conversion apparatus which is simple, has low technological, financial and maintenance requirements, and is scalable.

### BACKGROUND OF THE INVENTION

This invention generally relates to wave energy machine for converting energy from water wave into electricity. As fossil fuel supply diminishes, accompanied by an increasing and detrimental environmental impact from the by-products of consumption of fossil fuel, utilization of renewable energy becomes imperative.

The objectives of this invention are:
1. Harvest both the potential energy and the kinetic energy stored in waves.
2. Present a low-technology, low-investment wave energy conversion machine.

### SUMMARY OF THE INVENTION

In a preferred embodiment of the invention, a cylindrical float fitted with fins is disposed on the end of a forked arm, wherein the forked arm is affixed to a gear equipped with unidirectional drive device and mounted on an auxiliary shaft. The potential energy of the wave is harvested by translating the float's vertical motion into the rotation of the power output shaft which is connected to a generator.

The kinetic energy of the wave is harvested by transferring the float's rotation induced by the propagation of waves, then feeding to the power output shaft by gearing.

The technology used to build the wave energy machine presented by this invention involves basic mechanical principles. All necessary components are readily available, therefore the initial investment is low.

This wave energy machine is mounted above a framework anchored to the sea bed. Maintenance access is above water, therefore no diving is required to conduct maintenance operations. This is an advantage over those machines with under-water installations.

### PRIOR ART

Energy is stored in the vertical and horizontal motion of waves. U.S. Pat. No. 4,319,454 by Lucia harvests the energy in the down-phase of the wave. U.S. Pat. No. 4,389,843 by Lamberti and U.S. Pat. No. 4,598,547 by Michael Danihel harvests the vertcial phases of waves. All three prior arts do not harvest the energy in the horizontal motion. Since the specific weight of water is quite heavy, the horizontal motion energy is no less important than the vertical motion energy. Being able to harvest the energy stored in both of the wave's motions is what makes this idea unique.

### Principle

Refer to FIG. 1, when the wave propagates toward the finned float, it causes the float to move up and down, and the arm pivots accordingly. During the upward travel, the teeth on the outside of the gear affixed to the arm drive the pinion on the power output shaft, thereby transferring energy to generator. During the downward travel due to gravity, the unidirectional drive on the gear affixed to the arm engages and forcing the auxiliary shaft to rotate. This rotation is further transmitted to the power output shaft through gearing involving a second unidirectional drive device mounted on the auxiliary shaft. Thereby, conversion of potential energy into electricity is realized.

For the kinetic energy conversion, the wave pushes on the fins forcing the float to rotate. This rotation is transmitted to the auxiliary shaft by pulleys, and the kinetic energy is transferred to the power output shaft. To avoid conflict, one of the pulleys is also fitted with unidirectional drive to prevent the braking effect in case the float rotates too slowly.

### Description of the Preferred Embodiment

FIG. 2 illustrates a wave energy machine embodying the principles of this invention. Float 1 has multiple fins affixed to its cylindrical body. The float is journalled to the forked end of the arm 2 for rotation. Gear 3 with unidirectional drive is mounted on the auxiliary shaft 11. The gear 3 is meshed with gear 4 which is mounted on the power output shaft 7. Gear 4 is fitted with the unidirectional drive as well. The power output shaft is coupled to generator 8 which has a gear box for stepping up the RPM required for electricity generation.

Extended from the float is a shaft carrying pulley 9 which is chained to pulley 10 mounted on the auxiliary shaft 11. Pulley 10 is also fitted with unidirectional drive.

Gear 5 with unidirectional drive is mounted on the power output shaft. Chained to gear 5 is a gear 6 which is affixed to the auxiliary shaft 11.

When the wave lifts up float 1, arm 2 swings upwards. Gear 3 drives gear 4, the unidirectional drive on gear 4 engages and power output shaft rotates. But the auxiliary shaft is unaffected by the up swing of the arm because the unidirectional drive on gear 3 is not engaged during the up swing of the arm.

During the down swing of the arm, the unidirectional drive on gear 4 disengages; but the unidirectional drive on gear 3 engages and the auxiliary shaft 11 rotates. The rotation of the auxiliary shaft is further transferred to the power output shaft 7 through gear 6 and gear 5.

The rotation of the float 1 is transferred to the power output shaft 7 through gear 9, gear 10, auxiliary shaft 11, gear 6, and gear 5.

Multiples of the above basic units can be ganged together to scale up the energy conversion capacity. Furthermore, the floats can be disposed on both the upwind and downwind sides of the anchoring columns for better utilization of the site.

The outline above is of a basic unit. Variations can be achieved by using numerous various components. Such variations should be considered within the scope this invention. Below are some examples of variations:
Replace the forked arm with straight toothed racks mounted onto the float for driving the shafts in harvesting the potential energy.
Use only one shaft if the gear at the end of the arm is meshed to a planetary gear mechanism equipped with unidirectional drive device.
Use modified automobile transmission with electrical gear shift; this allows the elimination of one shaft.
Add isolation device between shafts to aid maintenance.
Add height adjustment mechanism to change the height of the columns.
Incorporate electric or electronic components or circuits.
Replace unidirectional drive device with electronic or mechanical clutch.
Vary the shape or arrangement of floats.

### DESCRIPTION OF DRAWINGS

FIG. 1 shows the working principle.

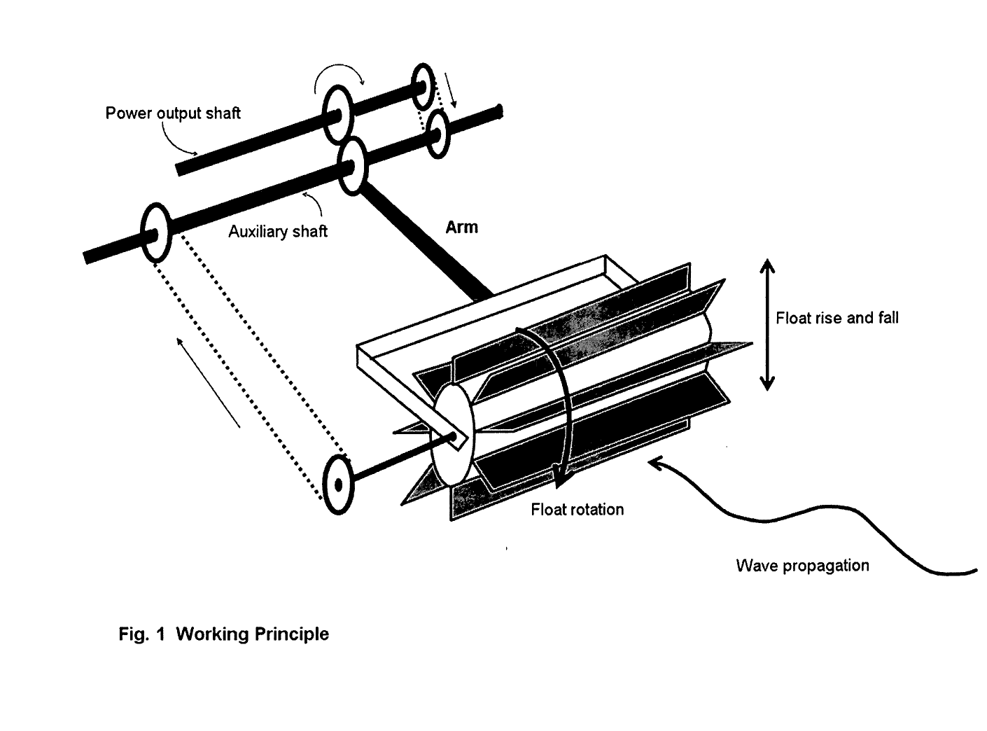

FIG. 2 shows a preferred embodiment.

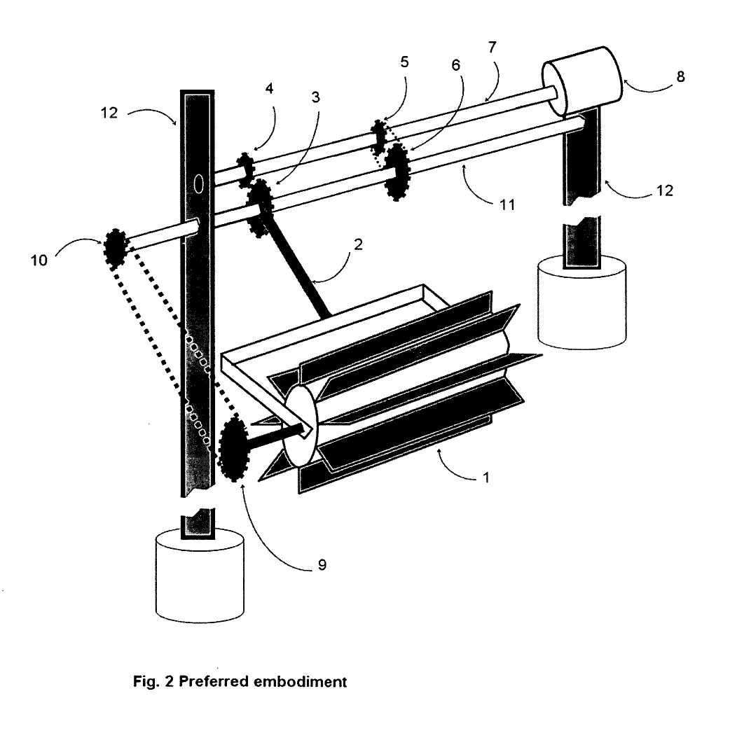

FIG. 3 shows a float with foldable fins.

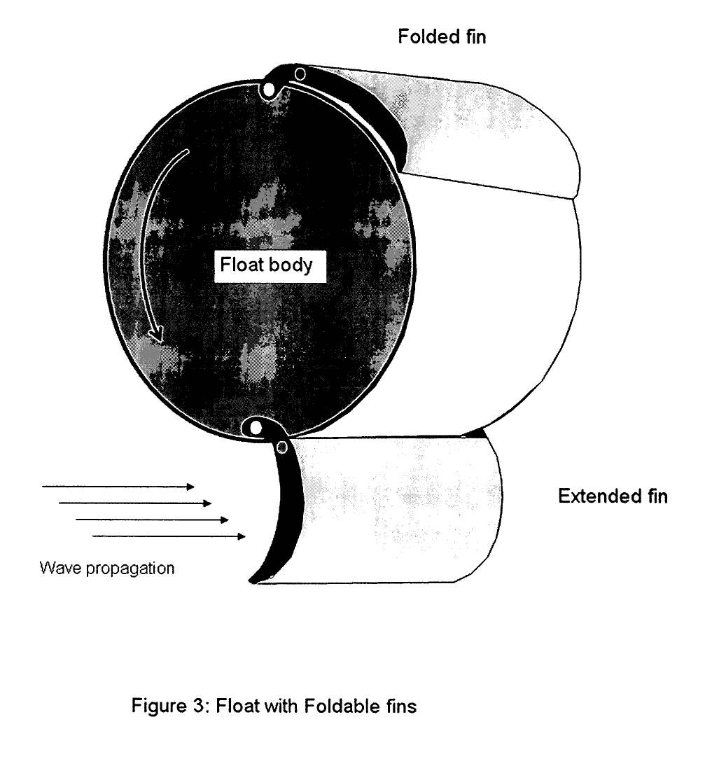

What is claimed is:

1. A wave energy machine comprising supporting columns anchored to sea bed, a power output shaft and an auxiliary shaft both journalled to said supporting columns for rotation, said power output shaft with two gears which are equipped with unidirectional drive device for rotating said power output shaft in one direction only, said auxiliary shaft carrying:
a. A gear affixed to said auxiliary shaft and chained to one of two said gears on said power output shaft causing both said shafts to rotate in phase.
b. A gear affixed to an arm and meshed to one of two said gears which are equipped with unidirectional drive device for rotating said power output shaft during up swing travel of said arm, said gear equipped with unidirectional drive device for rotating said auxiliary shaft in phase with said power output shaft during the down swing travel of said arm, buoyancy means journalled to the end of said arm for rotation, said buoyancy means configured with protruding surfaces for receiving load, a gear affixed to a shaft which extends from said buoyancy means for transferring the rotation of said buoyancy means.
c. A gear equipped with unidirectional drive device chained to said gear affixed to said shaft which extends from said buoyancy means in b, wherein said gear rotates said auxiliary shaft in phase with said power output shaft.

2. The structure according to claim 1 wherein said buoyancy means equipped with foldable protruding surfaces for reducing drag when said protruding surfaces retreat from water.

3. A scaled up structure comprising multiple units according to claim 1 transmitting power to one generator.

4. The structure according to claim one with floats disposed on both upwind and downwind sides of the columns.
